(19) United States
(12) Patent Application Publication
(10) Pub. No.: US 2024/0112084 A1
(43) Pub. Date: Apr. 4, 2024

(54) Scalable Feature Selection Via Sparse Learnable Masks

(71) Applicant: Google LLC, Mountain View, CA (US)

(72) Inventors: Sercan Omer Arik, San Francisco, CA (US); Yihe Dong, New York, NY (US)

(21) Appl. No.: 18/372,900

(22) Filed: Sep. 26, 2023

Related U.S. Application Data
(60) Provisional application No. 63/410,883, filed on Sep. 28, 2022.

(51) Int. Cl. G06N 20/00

(52) U.S. Cl. CPC G06N 20/00

(57) ABSTRACT

Aspects of the disclosure are directed to a canonical approach for feature selection referred to as sparse learnable masks (SLM). SLM integrates learnable sparse masks into end-to-end training. For the fundamental non-differentiability challenge of selecting a desired number of features, SLM includes dual mechanisms for automatic mask scaling by achieving a desired feature sparsity and gradually tempering this sparsity for effective learning. SLM further employs an objective that increases mutual information (MI) between selected features and labels in an efficient and scalable manner. Empirically, SLM can achieve or improve upon state-of-the-art results on several benchmark datasets, often by a significant margin, while reducing computational complexity and cost.

### CROSS-REFERENCE TO RELATED APPLICATIONS

The present application claims the benefit of the filing date of U.S. Provisional Patent Application No. 63/410,883, filed Sep. 28, 2022, the disclosure of which is hereby incorporated herein by reference.

### BACKGROUND

In many machine learning scenarios, a significant portion of input features may be irrelevant to generating outputs. Therefore, feature selection is utilized to filter out irrelevant features from the input features. Feature selection can bring multitude of benefits in machine learning. A smaller number of features can yield superior generalization, and hence better test accuracy, by minimizing information extraction from spurious patterns that do not hold consistently and by more optimally utilizing the model capacity on the most relevant features. In addition, reducing the number of input features can decrease the computational complexity and cost for deployed models, allowing for a decrease in infrastructure requirements to support the features, as the deployed models can learn mappings from input data with smaller dimensions. Further, reducing the number of input features can improve interpretability and controllability, as users can focus on understanding outputs of deployed models from a smaller subset of input features. As an example, feature selection can consider the predictive model itself, as an optimal set of features would depend on how mapping occurs between inputs and outputs. This may be referred to as embedded feature selection and can include regularization techniques and extensions. However, a fundamental challenge, especially with respect to deep learning, is that selection operations are non-differentiable, given a target count for selected features, which can require soft approximations for feature selection and result in lower quality outputs.

### BRIEF SUMMARY

Aspects of the disclosure are directed to a canonical approach for feature selection referred to as sparse learnable masks (SLM). SLM integrates learnable sparse masks into end-to-end training. For the fundamental non-differentiability challenge of selecting a desired number of features, SLM includes dual mechanisms for automatic mask scaling by achieving a desired feature sparsity and gradually tempering this sparsity for effective learning. SLM further employs an objective that increases mutual information (MI) between selected features and labels in an efficient and scalable manner Empirically, SLM can achieve or improve upon state-of-the-art results on several benchmark datasets, often by a significant margin, while reducing computational complexity and cost.

An aspect of the disclosure provides for a method for training a machine learning model with scalable feature selection, including: receiving, by one or more processors, a plurality of features for training the machine learning model; initializing, by the one or more processors, a learnable mask vector representing the plurality of features; receiving, by the one or more processors, a number of features to be selected; generating, by the one or more processors, a sparse mask vector from the learnable mask vector; selecting, by the one or more processors, a selected set of features of the plurality of features based on the sparse mask vector and the number of features to be selected; computing, by the one or more processors, a mutual information based error based on the selected set of features being input into the machine learning model; and updating, by the one or more processors, the learnable mask vector based on the mutual information based error.

In an example, the method further includes receiving, by the one or more processors, a total number of training steps. In another example, the receiving, generating, selecting, computing, and updating is iterative for the total number of training steps. In yet another example, the learnable mask vector updated after the total number of training steps includes a final selected set of features to be utilized by the machine learning model.

In yet another example, training the machine learning model further includes gradient-descent based learning. In yet another example, the method further includes removing non-selected features of the plurality of features. In yet another example, the method further includes applying a sparsemax normalization to the learnable mask vector.

In yet another example, the method further includes decreasing the number of features over a total number of training steps until reaching a target number of features to be selected. In yet another example, gradually decreasing the number of features to be selected is based on a discrete number of evenly spaced steps.

In yet another example, selecting the selected set of features further includes multiplying the sparse vector by a positive scalar based on a predetermined number of features. In yet another example, computing the mutual information based error is based on maximizing mutual information between a distribution of the selected set of features and a distribution of labels for the selected set of features. In yet another example, updating the learnable mask vector is based on minimizing the mutual information based error.

Another aspect of the disclosure provides for a system including: one or more processors; and one or more storage devices coupled to the one or more processors and storing instructions that, when executed by the one or more processors, cause the one or more processors to perform operations for training a machine learning model with scalable feature selection, the operations including: receiving a plurality of features for training the machine learning model; initializing a learnable mask vector representing the plurality of features; receiving a number of features to be selected; generating a sparse mask vector from the learnable mask vector; selecting a selected set of features of the plurality of features based on the sparse mask vector and the number of features to be selected; computing a mutual information based error based on the selected set of features being input into the machine learning model; and updating the learnable mask vector based on the mutual information based error.

In an example, the operations further include receiving a total number of training steps; the receiving, generating, selecting, computing, and updating is iterative for the total number of training steps; and the learnable mask vector updated after the total number of training steps includes a final selected set of features to be utilized by the machine learning model.

In another example, the operations further include removing non-selected features of the plurality of features. In yet another example, the operations further include applying a sparsemax normalization to the learnable mask vector. In yet another example, the operations further include gradually decreasing the number of features over a total number of training steps until reaching a target number of features to be selected.

In yet another example, selecting the selected set of features further includes multiplying the sparse vector by a positive scalar based on a predetermined number of features. In yet another example, computing the mutual information based error is based on maximizing mutual information between a distribution of the selected set of features and a distribution of labels for the selected set of features.

Yet another aspect of the disclosure provides for a non-transitory computer readable medium for storing instructions that, when executed by one or more processors, cause the one or more processors to perform operations for training a machine learning model with scalable feature selection, the operations including: receiving a plurality of features for training the machine learning model; initializing a learnable mask vector representing the plurality of features; receiving a number of features to be selected; generating a sparse mask vector from the learnable mask vector; selecting a selected set of features of the plurality of features based on the sparse mask vector and the number of features to be selected; computing a mutual information based error based on the selected set of features being input into the machine learning model; and updating the learnable mask vector based on the mutual information based error.

### BRIEF DESCRIPTION OF THE DRAWINGS

FIG. 1 depicts a block diagram of an example sparse learnable masks system for scalable feature selection according to aspects of the disclosure.

FIG. 2 depicts a block diagram of an example environment for implementing a sparse learnable masks system according to aspects of the disclosure.

FIG. 3 depicts a block diagram illustrating one or more machine learning model architectures according to aspects of the disclosure.

FIG. 4 depicts a flow diagram of an example process for training a machine learning model using scalable feature selection according to aspects of the disclosure.

FIG. 5 depicts a flow diagram of an example process for performing a training step for training the machine learning model using scalable feature selection according to aspects of the disclosure.

FIG. 6 depicts a table comparing accuracy for the sparse learnable masks system to other feature selection approaches over various datasets according to aspects of the disclosure.

FIG. 7 depicts a table comparing accuracy for the sparse learnable masks system to other feature selection approaches over various numbers of features to be selected according to aspects of the disclosure.

### DETAILED DESCRIPTION

The technology relates generally to scalable feature selection, which may be referred to herein as sparse learnable masks (SLM). SLM can be integrated into any deep learning or machine learning architecture due to its gradient-descent based optimization. SLM can utilize end-to-end learning through joint training with predictive models. SLM can improve scaling of feature selection, yielding a target number of features even when the number of input features or samples are large. SLM can modify learnable masks to select the target number of features while addressing differentiability challenges. Further, SLM can utilize improved mutual information (MI) regularization based on a quadratic relaxation of the MI between labels and selected features, conditioned on the probability that a feature is selected. SLM can demonstrate feature selection with improved results compared to state-of-the-art feature selection, resulting in higher quality models with reduced computational complexity and cost.

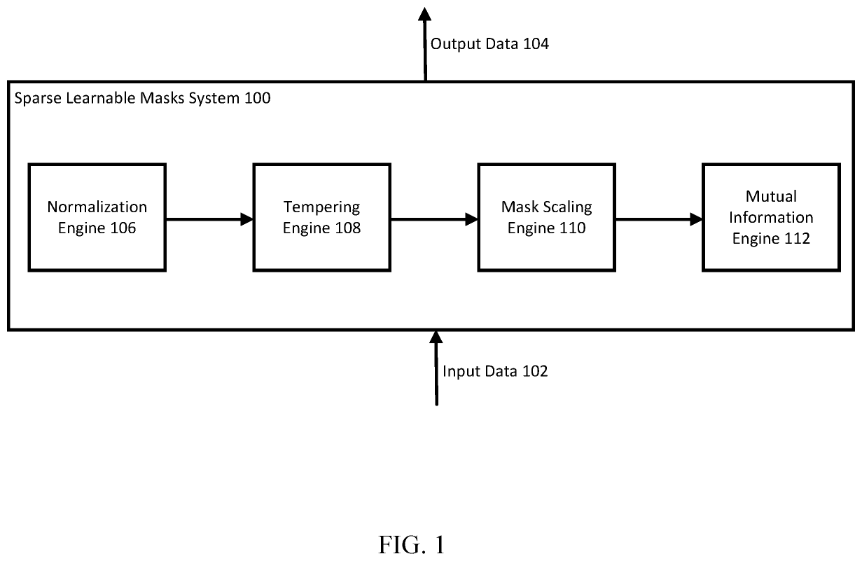

FIG. 1 depicts a block diagram of an example sparse learnable masks system 100 for scalable feature selection. The sparse learnable masks system 100 can be implemented on one or more computing devices in one or more locations.

The sparse learnable masks system 100 can be configured to receive input data 102, such as inference data and/or training data, for use in selecting features to train one or more machine learning models. For example, the sparse learnable masks system 100 can receive the input data 102 as part of a call to an application programming interface (API) exposing the sparse learnable masks system 100 to one or more computing devices. The input data 102 can also be provided to the sparse learnable masks system 100 through a storage medium, such as remote storage connected to the one or more computing devices over a network. The input data 102 can further be provided as input through a user interface on a client computing device coupled to the sparse learnable masks system 100.

The input data 102 can include training data associated with feature selection, such as covariate input data and target labels. The input data 102 can be numerical, such as categorical features mapped to embeddings. The input data 102 can include training data for any machine learning task, such as medical diagnosis, image classification, speech recognition, price forecasting, and/or fraud detection. The training data can be split into a training set, a validation set, and/or a testing set. An example training/validation/testing split can be an 80/10/10 split, although any other split may be possible. The training data can include examples of features and labels associated with the machine learning task.

The training data can be in any form suitable for training a machine learning model, according to one of a variety of different learning techniques. Learning techniques for training a model can include supervised learning, unsupervised learning, semi-supervised learning techniques, parameter-efficient techniques, and reinforcement learning techniques. For example, the training data can include multiple training examples that can be received as input by a model. The training examples can be labeled with a desired output for the model when processing the labeled training examples. The label and the model output can be evaluated through a loss function to determine an error, which can be back propagated through the model to update weights for the model. For example, a supervised learning technique can be applied to calculate an error between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

From the input data 102, the sparse learnable masks system 100 can be configured to output one or more results related to scalable feature selection, generated as output data 104. The output data 104 can include selected features associated with a machine learning task. As an example, the sparse learnable masks system 100 can be configured to send the output data 104 for display on a client or user display. As another example, the sparse learnable masks system 100 can be configured to provide the output data 104 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The sparse learnable masks system 100 can further be configured to forward the output data 104 to one or more other devices configured for translating the output data into an executable program written in a computer programming language. The sparse learnable masks system 100 can also be configured to send the output data 104 to a storage device for storage and later retrieval.

The sparse learning masks system 100 can integrate a feature selection layer into a machine learning architecture guided by gradient-descent based learning. As an example, let x∈R^{F}^{₀} denote covariate input data and y denote a target, such as class labels. The sparse learning masks system 100 can be integrated with a predictor model f_{θ}, with learnable parameters θ, that is applied to selected features xₛₚ∈R^{F}^{ₜ}, where Fₜ denotes the number of selected features at step t. The predictor model can be any architecture trained via gradient descent, such as a multi-layer perceptron or deep tabular data learning. Multiplication of a binary mask Mₛₚ can indicate feature selection operation. The sparse learnable masks system 100 can perform training for scalable feature selection as follows.

Input: input data x with target labels y;

Input: total training steps N;

Initialize: learnable mask argument M←all-ones vector;

For t=1 to N do:

Obtain a number of selected features Fₜ for step t;

Generate sparse mask Mₛₚ=sparsemax(M);

Select and weigh input features: xₛₚ=x·Mₛₚ where non-selected features are zeroed out;

Input the selected features into a predictor f_{θ}(xₛₚ) for a machine learning task;

Compute a training task loss l(xₛₚ,y) and MI loss E(xₛₚ,y); and

Update parameters θ and M using the task loss l and/or MI loss E (xₛₚ,y).

Task loss may refer to a target prediction task of the dataset, such as medical diagnosis, image classification, speech recognition, price forecasting, and/or fraud detection, and MI loss may refer to how well one or more selected features align with the dataset labels.

The sparse learnable masks system 100 can include a normalization engine 106, a tempering engine 108, a mask scaling engine 110, and a mutual information engine 112. The normalization engine 106, tempering engine 108, mask scaling engine 110, and mutual information engine 112 can be implemented as one or more computer programs, specially configured electronic circuitry, or any combination thereof.

The normalization engine 106 can be configured to combine sparse non-linear normalization with learnable feature selection vectors in SLM. For example, the normalization engine 106 can perform a sparsemax normalization to achieve feature sparsity. Sparsemax may refer to any normalization operation able to achieve sparsity, e.g., the output includes more than a threshold amount of 0 elements. The normalization engine 106 can perform sparsemax normalization by returning a Euclidean projection of an input vector onto a probability simplex. For example:

sparsemax(v):=argmin_{p∈Δ}_{^{K−1}}∥p−v∥² (1)

The probability simplex projection in sparsemax(v) can scale top values in v so they are equidistributed over [0,1]. This equidistribution can result in greater feature weight separation, encouraging discrimination among the features. The normalization engine 106 can apply the sparsemax normalization to a normalized mask argument to obtain a sparse feature mask. For example:

Mₛₚ=sparsemax(M) (2)

The tempering engine 108 can be configured to gradually decrease a number of features selected until reaching a target number of selected features F_{N}. For example:

$${F}_{t} = \{ \begin{matrix}{F}_{0} - t / {N}_{tmp} ( {F}_{0} - {F}_{N} ) & if t < {N}_{tmp} \\ {F}_{N} & if t \geq {N}_{tmp}\end{matrix} \qquad ( 3 )$$

F_{N} can denote the number of selected features at a step t and Nₜₘₚ can denote a tempering threshold. As examples, Nₜₘₚ=N/2or Nₜₘₚ=N/4, though any tempering threshold can be utilized. The tempering engine 108 can further be configured to decrease the number of features based on a discrete number of steps. The discrete number of steps can be evenly spaced. For example, the tempering engine 108 can decrease the number of features after every five steps. The tempering engine 108 allows the predictor model to learn from more than the final target number of features during training. The tempering engine 108 further allows for a more robust initialization for training the predictor model based on learning from all features initially compared to starting learning with the target number of features, as the randomness in the initial selection is seldom optimal.

The mask scaling engine 110 can be configured to scale the sparse feature mask to achieve a predetermined number of non-zero features. The sparsity in the sparsemax normalization can be based on where the projection lands on the probability simplex Δ^{K-1}. For a non-uniform vector v∈R, the mask scaling engine 110 can adjust the projection of v onto Δ^{K-1}, such as by multiplying v by a positive scalar.

Larger scalars may increase sparsity while smaller scalars may decrease sparsity. For example, for two dimensional data, the probability simplex Δ¹ in R² is the line connecting (0,1) and (1,0), with these two points as the simplex boundary. Let v=(x, y) be a point in R², and (z, w) be the projection of the point onto Δ¹. With a varying multiplier m, sparsemax(mv) can have varying degrees of sparsity. The projection (z,w)=sparsemax((x,y)) can be the unique point that satisfies (z,w)=argmin_{(z,w)}(∥y−w∥²+∥x−z∥²), where (z,w) is element wise positive and z+w=1. As (x,y) is scaled with m, sparsemax(m(x y))=argmin_{(z,w)}(∥my−w∥²+∥mx−z∥²). This projection distance can expand to: d(z,w):=∥my−w∥²+∥mx−z∥²=m²y²−2myw+w²+m²x²−2mxz+z². Hence, d(0,1)−d(0.5,0.5)=mx−my+0.5. For any (x,y) and m with y>x, sparsemax(m(x,y)) is closer to (0,1)∈Δ¹ whenever m>1/(2(y−x)) and closer to (0.5,0.5) otherwise. Since the projection is linear, varying the multiplier m varies the sparsity of sparsemax((x,y)). For example, larger multipliers can result in sparser output.

The mask scaling engine 110 can obtain a predetermined number of nonzero elements in the sparse feature mask by multiplying by a scalar. For example, given a vector v∈R^{K}, the mask scaling engine 110 can obtain F nonzero elements in sparsemax(v) by multiplying v by the scalar:

$$m = \{ \begin{matrix}{( {\sum }_{i = 1}^{F + 1} {v}_{( i )} - ( F + 1 ) * {v}_{( F + 1 )} )}^{- 1} & if \vert sparsemax ( v ) > 0 \vert > F \\ {( {\sum }_{i = 1}^{F} {v}_{( i )} - F * {v}_{F} )}^{- 1} & if \vert sparsemax ( v ) > 0 \vert < F\end{matrix} \qquad ( 4 )$$

where v₍₁₎≥v₍₂₎ . . . v_{(K)} denote sorted elements of v in descending order.

The mutual information engine 112 can be configured to increase the mutual information (MI) between the distribution of the selected features and the distribution of the labels as an inductive bias to the model that accounts for sample labels during feature selection. MI between distributions may refer to how similar or correlated the distributions are. For example, the mutual information engine 112 can maximize the MI between the distribution of the selected features and the distribution of the labels. The mutual information engine 112 can condition the MI on the probability that a feature is selected given by the mask M.

As an example, X can denote a random variable representing features and Y can denote a random variable representing labels, with value spaces X∈X and Y∈Y. Maximizing the conditional or the joint MI between selected features and labels can require computation of an exponential number of probabilities, the optimization of which can be intractable. Therefore, the mutual information engine 112 can conduct a quadratic relaxation of the MI which is end-to-end differentiable. As an example, when the mutual information engine 112 models X and Y as random variables, their MI I (X,Y) can be defined, and after marginalizing over X, can be determined as:

I(X,Y):=Σ_{x∈X}Σ_{y∈Y}P_{X,Y}(x,y) log log P_{x,y}(x,y)/P_{X}(x)P_{Y}(y)=(Σ_{x∈X}Σ_{y∈Y}P_{X,Y}(x,y) log log P_{X,Y}(x,y)/P_{X}(x))−Σ_{y∈Y}P_{Y}(y) log log P_{Y}(y) (5)

The mutual information engine 112 can ignore the second term during optimization, since the second term does not depend on features X. Therefore, the mutual information engine 112 can perform optimization to increase MI based on a quadratic relaxation I_{q}(X,Y) to simplify I(X,Y) while retaining much of its properties, allowing for a reduction in computation cost and memory usage. For example:

I_{q}(X,Y):=(Σ_{x∈X}Σ_{y∈Y}P_{X,Y}(x,y)²/P_{X}(x))−Σ_{y∈Y}P_{Y}(y)² (6)

In this example, p log log q is relaxed to pq, as both p log log q and pq are convex with respect to p and q. From an optimization perspective, I_{q}(X,Y) can approximate I(X,Y) where P_{X,Y}(X,Y)/P_{X}(x) and P_{Y}(y) are in within (1−δ,1+δ). Here, using Taylor expansion, log log (q)=log log (q₀)+(q−q₀)/q₀−(q−q₀)²/2q₀²+ . . . . When q₀=1, the Taylor expansion becomes

$$log log ( q ) \approx ( q - 1 ) - \frac{{( q - 1 )}^{2}}{2} = - \frac{3}{2} + 2 q - {q}^{2} / 2.$$

Therefore, p log log q can have a second order approximation −3p/2+2pq or −3p/2+2p² when p=q. In I(X,Y), p can be P_{X,Y}(x,y) in the first term and P_{Y}(y) in the second. Since both P_{X,Y}(x,y) and P_{Y}(y) are probabilities and sum to 1 across the label space for any given sample, the linear term −3p/2 does not affect gradient descent optimization. Normalization can be a hard constraint enforced during training that supersedes this linear term in the objective. Therefore, during optimization,

$${P}_{X , Y} ( x , y ) log log \frac{{P}_{X , Y} ( x , y )}{{P}_{X} ( x )} and {{P}_{X , Y} ( x , y )}^{2} / {P}_{X} ( x ) ,$$

and thus I_{q}(X,Y) and I(X,Y), agree based on their second order approximation.

The mutual information engine 112 can connect I_{q}(X,Y) with predictions from the predictor model using Lagrange multipliers. As an example, let R(x,y): X×Y→[0,1] denote a probability outcome of the predictor model for sample x and outcome y. The below equations model a discrete label case, such as for classification, but a case where labels are continuous can be reduced to the discrete label case through quantization. A quadratic error term E(X,Y) can be defined in terms of R(x, y) and expanded as follows:

E(X,Y):=Σ_{x∈X}Σ_{y∈Y}P_{X,Y}(x,y)((1−R(x,y))²+Σ_{y′∈Y\y}R(x,y′)²)=1−2Σ_{x∈X}Σ_{y∈Y}P_{X,Y}(x,y)R(x,y)+Σ_{x∈X}Σ_{y′∈Y}P_{X}(x)R(x,y′)² (7)

The mutual information engine 112 can increase, such as maximize, the quadratic relaxation of MI by decreasing, such as minimizing, the error. For example:

E(X,Y)=1−Σ_{y∈Y}P_{Y}(y)²−I_{q}(X,Y) (8)

Lagrange multipliers can be used to solve for the optimal model predictions in terms of P_{X,Y}(x,y) and P_{X}(x), which can be used to express the objective E(X,Y) as a function of I_{q}(X,Y).

With respect to feature selection, the mutual information engine 112 can select a given number of features that reduce, e.g., minimize, E(X,Y). For example, given a dataset, I can denote the index set of the dataset samples, J can denote the index set of the features, and L can denote the set of possible labels. Further, S⊂J can denote the index set of features selected, Xᵢ^{S} can denote the random variable representing a selected subset of features for the i^{th} sample. Then, the joint probability can be P_{X,Y}(x,y)=|{i ∈I|Xᵢ^{S}=x,Yᵢ=y}|/|I| and the error can be defined as:

E(X,Y):=Σ_{x∈X}Σ_{y∈Y}P_{X,Y}(x,y)((1−R(x,y))²+Σ_{y≠Y}_{ᵢ}R(x,y′)²)=Σ_{i∈I}((1−RXᵢ^{S},Yᵢ))²+Σ_{y≠Y}_{ᵢ}R(Xᵢ^{S},y)²/|I|) (9)

During training, the mutual information engine 112 can reduce, e.g., minimize, error under one or more consistency constraints. As an example, for two samples i₁ and i₂ that have the same values in the selected features, e.g., Xᵢ_{₁}^{S}=Xᵢ_{₂}^{S}, their model predictions are the same, e.g., R(Xᵢ_{₁}^{S},Yᵢ_{₁})=R(Xᵢ_{₂}^{S},Yᵢ_{₂}). This constraint can be included as a soft consistency regularization term r_{cs}, converting constrained optimization to unconstrained optimization with regularization. For example:

r_{cs}:=Σ_{{i}_{₁}ᵢ_{₂}_{}∈I}_{²}_{,i}_{₁}_{<i}_{₂}P(Xᵢ_{₁}^{S}=Xᵢ_{₂}^{S})(R(Xᵢ_{₁}^{S},Yᵢ_{₁})−R(Xᵢ_{₂}^{S},Yᵢ_{₂}))² (10)

where P(Xᵢ_{₁}^{S}=Xᵢ_{₂}^{S}) is the probability that the samples Xᵢ_{₁}^{S} and Xᵢ_{₂}^{S} take the same values in the selected feature set S. The learned mask can include probabilities M={pⱼ}_{j∈J} where pⱼ is the probability that a feature j is selected. Then, P(Xᵢ_{₁}^{S}=Xᵢ_{₂}^{S}) can be the product over probabilities that the feature j is not selected if Xᵢ_{₁}^{S} and Xᵢ_{₂}^{S} differ at feature j. For example,

$$P ( {X}_{{i}_{1}}^{S} = {X}_{{i}_{2}}^{S} ) = {\prod }_{{X}_{{i}_{1}}^{( j )} \neq {X}_{{i}_{2}}^{( j )}} ( 1 - {p}_{j} ) .$$

In this probabilistic form, the consistency regularization encourages the selection of features with diverse ranges, since it encourages higher pⱼ for the features with many Xᵢ_{₁}^{(j)}≠Xᵢ_{₂}^{(j)} pairs. Therefore, as an example, the regularized objective to increase, e.g., maximize, the MI between selected features and the labels can be:

E(X,Y)=Σ_{i∈I}((1−R(Xᵢ^{S},Yᵢ))²+Σ_{y≠T}_{ᵢ}R(Xᵢ^{S},y)²/|I|)+r_{cs} (11)

where

$${r}_{cs} = {\sum }_{\{ {i}_{1} , {i}_{2} \} ∈ {I}^{2} , {i}_{1} < {i}_{2}} ( {\prod }_{{X}_{{i}_{1}}^{( j )} \neq {X}_{{i}_{2}}^{( j )}} ( 1 - {p}_{j} ) ( R ( {X}_{{i}_{1}}^{S} , {Y}_{{i}_{1}} ) - {R ( {X}_{{i}_{2}}^{S} , {Y}_{{i}_{2}} )}^{2} ) .$$

The mutual information engine 112 can enforce the regularization term batch-wise and can vectorize the regularization term for a parallel computation of Xᵢ_{₁}^{(j)}≠Xᵢ^{(j)} pairs per batch. When the labels are in a continuous space, the reduction, e g , minimization, objective with the consistency regularization can be derived similarly. For example:

E(X,Y)=Σ_{i∈I}(Yᵢ−R(Xᵢ^{S}))²/|I|+r_{cs} (12)

The sparse learnable masks system 100 can reduce computational complexity through the normalization engine 106, tempering engine 108, mask scaling engine 110, and/or mutual information engine 112, resulting in lower processing power and memory usage while still achieving desired results. The sparsemax operation can be dominated by sorting and can have a complexity O(F₀ log log F₀) per sample, with an overall complexity of O(nF₀ log log F₀). The consistency regularization r_{cs} in the MI-increasing objective E(X,Y) can have a complexity O(nbF_{N}), as the calculation occurs over the selected feature index set and is done between each sample and other in its batch. The non-regularization component in E(X,Y) has a complexity nc where c is the constant for the number of discrete or binned labels. As an example, with a multi-layer perceptron classifier having a complexity O(nh²), the overall computations have a complexity O(F₀ log log F₀+nbF_{N}+nc+nh²), such that the dependence on the total number of features is Õ(F₀), allowing the sparse learnable masks system 100 to scale to a large number of features.

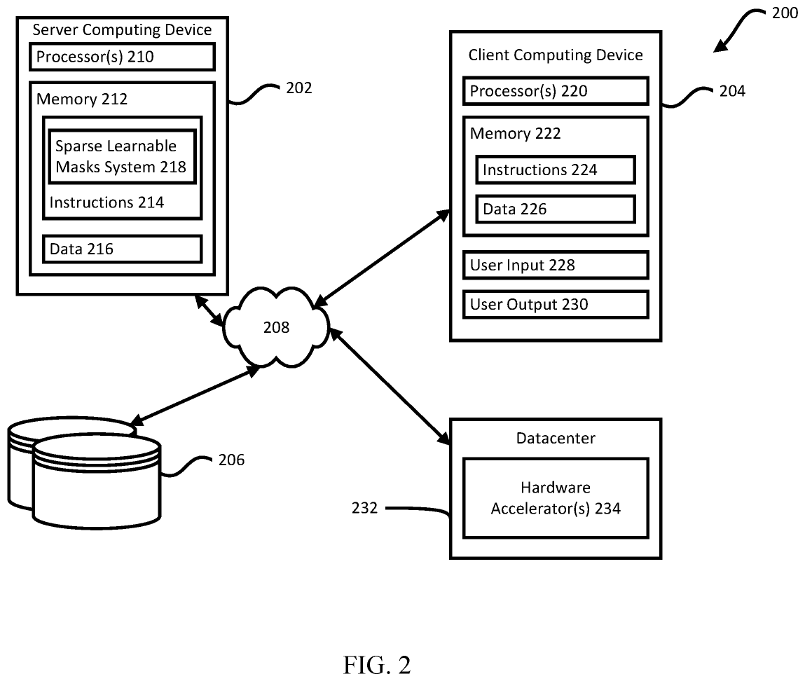

FIG. 2 depicts a block diagram of an example environment 200 for implementing a sparse learnable masks system 218. The sparse learnable masks system 218 can be implemented on one or more devices having one or more processors in one or more locations, such as in server computing device 202. Client computing device 204 and the server computing device 202 can be communicatively coupled to one or more storage devices 206 over a network 208. The storage devices 206 can be a combination of volatile and non-volatile memory and can be at the same or different physical locations than the computing devices 202, 204. For example, the storage devices 206 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 202 can include one or more processors 210 and memory 212. The memory 212 can store information accessible by the processors 210, including instructions 214 that can be executed by the processors 210. The memory 212 can also include data 216 that can be retrieved, manipulated, or stored by the processors 210. The memory 212 can be a type of transitory or non-transitory computer readable medium capable of storing information accessible by the processors 210, such as volatile and non-volatile memory. The processors 210 can include one or more central processing units (CPUs), graphic processing units (GPUs), field-programmable gate arrays (FPGAs), and/or application-specific integrated circuits (ASICs), such as tensor processing units (TPUs).

The instructions 214 can include one or more instructions that, when executed by the processors 210, cause the one or more processors 210 to perform actions defined by the instructions 214. The instructions 214 can be stored in object code format for direct processing by the processors 210, or in other formats including interpretable scripts or collections of independent source code modules that are interpreted on demand or compiled in advance. The instructions 214 can include instructions for implementing a sparse learnable masks system 218, which can correspond to the sparse learnable masks system 100 of FIG. 1. The sparse learnable masks system 218 can be executed using the processors 210, and/or using other processors remotely located from the server computing device 202.

The data 216 can be retrieved, stored, or modified by the processors 210 in accordance with the instructions 214. The data 216 can be stored in computer registers, in a relational or non-relational database as a table having a plurality of different fields and records, or as JSON, YAML, proto, or XML documents. The data 216 can also be formatted in a computer-readable format such as, but not limited to, binary values, ASCII, or Unicode. Moreover, the data 216 can include information sufficient to identify relevant information, such as numbers, descriptive text, proprietary codes, pointers, references to data stored in other memories, including other network locations, or information that is used by a function to calculate relevant data.

The client computing device 204 can also be configured similarly to the server computing device 202, with one or more processors 220, memory 222, instructions 224, and data 226. The client computing device 204 can also include a user input 228 and a user output 230. The user input 228 can include any appropriate mechanism or technique for receiving input from a user, such as keyboard, mouse, mechanical actuators, soft actuators, touchscreens, microphones, and sensors.

The server computing device 202 can be configured to transmit data to the client computing device 204, and the client computing device 204 can be configured to display at least a portion of the received data on a display implemented as part of the user output 230. The user output 230 can also be used for displaying an interface between the client computing device 204 and the server computing device 202. The user output 230 can alternatively or additionally include one or more speakers, transducers or other audio outputs, a haptic interface or other tactile feedback that provides non-visual and non-audible information to the platform user of the client computing device 204.

Although FIG. 2 illustrates the processors 210, 220 and the memories 212, 222 as being within the respective computing devices 202, 204, components described herein can include multiple processors and memories that can operate in different physical locations and not within the same computing device. For example, some of the instructions 214, 224 and the data 216, 226 can be stored on a removable SD card and others within a read-only computer chip. Some or all of the instructions 214, 224 and data 216, 226 can be stored in a location physically remote from, yet still accessible by, the processors 210, 220. Similarly, the processors 210, 220 can include a collection of processors that can perform concurrent and/or sequential operation. The computing devices 202, 204 can each include one or more internal clocks providing timing information, which can be used for time measurement for operations and programs run by the computing devices 202, 204.

The server computing device 202 can be connected over the network 208 to a data center 232 housing any number of hardware accelerators 234. The data center 232 can be one of multiple data centers or other facilities in which various types of computing devices, such as hardware accelerators, are located. Computing resources housed in the data center 232 can be specified for deploying models with scalable feature selection, as described herein.

The server computing device 202 can be configured to receive requests to process data from the client computing device 204 on computing resources in the data center 232. For example, the environment 200 can be part of a computing platform configured to provide a variety of services to users, through various user interfaces and/or application programming interfaces (APIs) exposing the platform services. The variety of services can include medical diagnosis, image classification, speech recognition, price forecasting, and/or fraud detection utilizing the scalable feature selection as described herein. The client computing device 204 can transmit input data associated with feature selection, such as covariate input data and target labels. The sparse learnable masks system 218 can receive the input data, and in response, generate output data including a selected predetermined number of features with increased mutual information between the selected features and the labels.

As other examples of potential services provided by a platform implementing the environment, the server computing device 202 can maintain a variety of models in accordance with different constraints available at the data center 232. For example, the server computing device 202 can maintain different families for deploying models on various types of TPUs and/or GPUs housed in the data center 232 or otherwise available for processing.

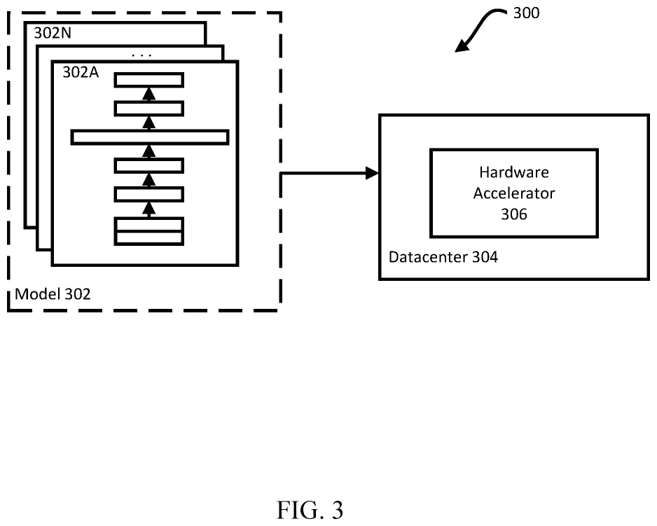

FIG. 3 depicts a block diagram 300 illustrating one or more machine learning model architectures 302, more specifically 302A-N for each architecture, for deployment in a datacenter 304 housing a hardware accelerator 306 on which the deployed machine learning models 302 will execute, such as for scalable feature selection as described herein. The hardware accelerator 306 can be any type of processor, such as a CPU, GPU, FPGA, or ASIC such as a TPU.

An architecture 302 of a machine learning model can refer to characteristics defining the model, such as characteristics of layers for the model, how the layers process input, or how the layers interact with one another. The architecture 302 of the machine learning model can also define types of operations performed within each layer. One or more machine learning model architectures 302 can be generated that can output results, such as for scalable feature selection. Example model architectures 302 can correspond to a multi-layer perceptron and/or deep tabular data learning.

Referring back to FIG. 2, the devices 202, 204 and the data center 232 can be capable of direct and indirect communication over the network 208. For example, using a network socket, the client computing device 204 can connect to a service operating in the data center 232 through an Internet protocol. The devices 202, 204 can set up listening sockets that may accept an initiating connection for sending and receiving information. The network 208 can include various configurations and protocols including the Internet, World Wide Web, intranets, virtual private networks, wide area networks, local networks, and private networks using communication protocols proprietary to one or more companies. The network 208 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 208, in addition or alternatively, can also support wired connections between the devices 202, 204 and the data center 232, including over various types of Ethernet connection.

Although a single server computing device 202, client computing device 204, and data center 232 are shown in FIG. 2, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing optimization models, and any combination thereof.

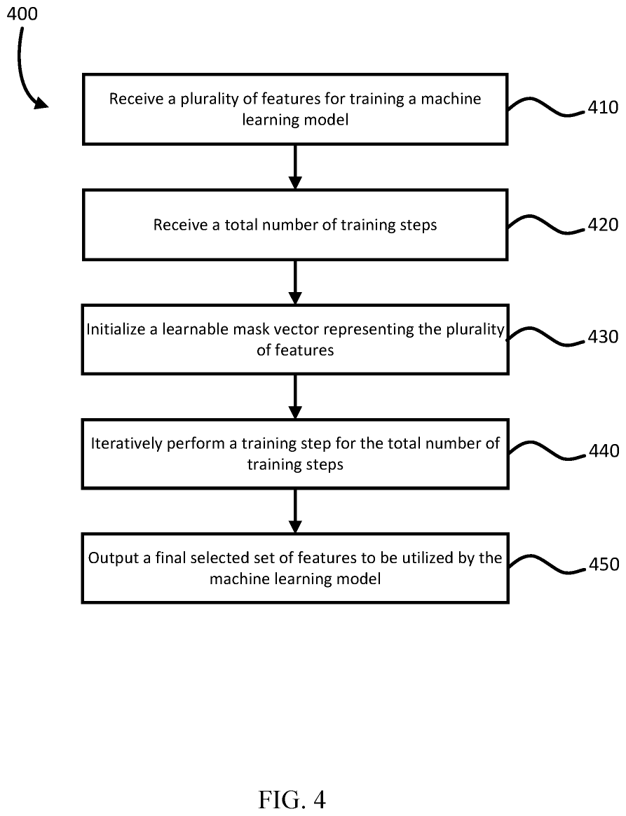

FIG. 4 depicts a flow diagram of an example process 400 for training a machine learning model using scalable feature selection. The example process 400 can be performed on a system of one or more processors in one or more locations, such as the sparse learnable masks system 100 as depicted in FIG. 1.

As shown in block 410, the sparse learnable masks system 100 can be configured to receive a plurality of features for training a machine learning model. The plurality of features can be numerical, such as categorical features mapped to embeddings. The plurality of features can be associated with any machine learning task, such as medical diagnosis, image classification, speech recognition, price forecasting, and/or fraud detection. The machine learning model can include any architecture trained using gradient descent, such as a multi-layer perceptron or a deep tabular data learning model. The sparse learnable masks system 100 can further receive a plurality of labels associated with the plurality of features. For example, each of the plurality of labels can denote a target based on one or more of the plurality of features, such as classification labels.

As shown in block 420, the sparse learnable masks system 100 can be configured to receive a total number of training steps. The total number of training steps can correspond to a number of iterations in training the machine learning model, such as for a particular machine learning task.

As shown in block 430, the sparse learnable masks system 100 can be configured to initialize a learnable mask vector representing the plurality of features. For example, the learnable mask vector can be initialized with all ones to indicate all of the plurality of features are initially selected.

As shown in block 440, the sparse learnable masks system 100 can be configured to iteratively perform a training step for the total number of training steps. Performing the training step can include receiving a number of features to be selected for the training step; generating a sparse mask vector from the learnable mask vector; selecting a set of features of the plurality of features based on the sparse mask vector and the number of features to be selected; computing a mutual information based error based on the selected set of features being input into the machine learning model; and updating the learnable mask vector based on the mutual information-based error.

As shown in block 450, the sparse learnable masks system 100 can be configured to output a final selected set of features, represented by the updated learnable mask vector, to be utilized by the machine learning model. For example, the updated learnable mask vector can have ones indicating selected features and zeros indicating non-selected features. The sparse learnable masks system 100 can further output a trained machine learning model that utilizes the final selected set of features when performing the machine learning task.

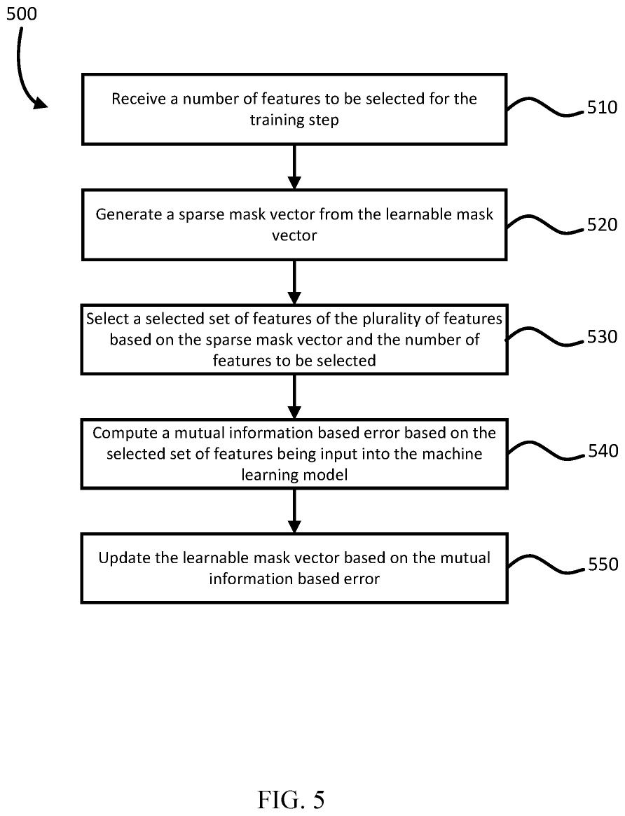

FIG. 5 depicts a flow diagram of an example process 500 for performing a training step for training the machine learning model using scalable feature selection. The example process 500 can be performed on a system of one or more processors in one or more locations, such as the sparse learnable masks system 100 as depicted in FIG. 1.

As shown in block 510, the sparse learnable masks system 100 can be configured to receive a number of features to be selected for the training step. The number of features to be selected can be gradually decreased over a total number of training steps until reaching a target number of features to be selected. Gradually decreasing the number of features to be selected can be based on a discrete number of evenly spaced steps. For example, the number of features to be selected can start at 50 features and gradually decrease every 5^{th} training step. The gradual decrease of selected features can be based on a tempering threshold, which can be a fraction of the number of training steps.

As shown in block 520, the sparse learnable masks system 100 can be configured to generate a sparse mask vector from the learnable mask vector. The sparse learnable masks system 100 can apply a sparsemax normalization to the learnable mask vector. For example, the sparse learnable masks system 100 can return a Euclidean projection of the learnable mask vector onto a probability simplex. The projection can scale values in the learnable mask vector to be equidistributed over [0,1].

As shown in block 530, the sparse learnable masks system 100 can be configured to select a set of features of the plurality of features based on the sparse mask vector and the number of features to be selected. The sparse learnable masks system 100 can scale the sparse feature mask to achieve a predetermined number of non-zero values representing a set of features to be selected. For example, the sparse learnable masks system 100 can adjust the projection in the learnable mask vector by multiplying by a positive scalar. Larger positive scalars may increase sparsity while smaller positive scalars may decrease sparsity in the sparse mask vector.

As shown in block 540, the sparse learnable masks system 100 can be configured to compute a mutual information based error based on the selected set of features being input into the machine learning model. For example, computing the mutual information based error can be based on maximizing mutual information between a distribution of the selected set of features and a distribution of labels for the selected set of features. The mutual information can be conditioned on the probability that a feature is selected based on the sparse feature mask. The sparse learnable masks system 100 can further be configured to compute a training task loss based on the selected set of features being input into the machine learning model, such as by calculating a difference between model predictions and dataset labels.

As shown in block 550, the sparse learnable masks system 100 can update the learnable mask vector based on the mutual information based error. The sparse learnable masks system 100 can further update the learnable mask vector based on the training task loss. The sparse learnable masks system 100 can further update one or more parameters for the machine learning model based on the mutual information based error and/or the training task loss. Updating the learnable mask vector can be based on an objective of reducing, e.g., minimizing, the mutual information based error and/or training task loss. Updating the learnable mask vector can include removing non-selected features of the plurality of features. For example, the updated learnable mask vector can have ones indicating selected features and zeros indicating non-selected features or floating point numbers to indicate the probability of selecting a feature.

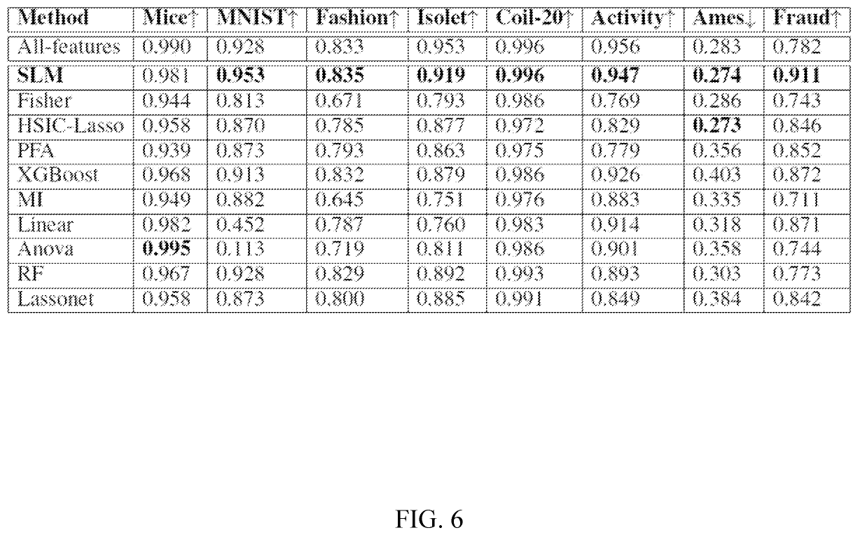

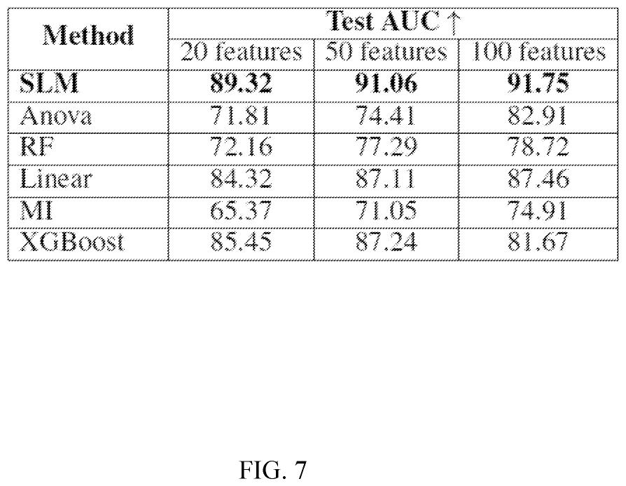

As illustrated in FIGS. 6-7, SLM can achieve or improve upon other approaches to feature selection while reducing computational complexity and cost. A similar hyperparameter search space and budget, as well as data splits and preprocessing approaches, were employed for each approach to ensure a fair comparison. The various datasets include the following domains: Mice, MNIST, Fashion-MNIST, Isolet, Coil-20, Activity, Ames, Fraud. Mice refers to protein expression levels measured in the cortex of normal and trisomic mice who had been exposed to different experimental conditions. Each feature is the expression level of one protein. MNIST and Fashion-MNIST refer to 28-by-28 grayscale images of hand-written digits and clothing items, respectively. The images are converted to tabular data by treating each pixel as a separate feature. Isolet refers to preprocessed speech data of people speaking the names of the letters in the English alphabet with each feature being one of the preprocessed quantities, including spectral coefficients and sonorant features. Coil-20 refers to centered grayscale images of 20 objects taken at pose intervals of 5 degrees amounting to 72 images for each object. During preprocessing, the images were resized to produce 20-by-20 images, with each feature being one of the pixels. Activity refers to sensor data collected from a smartphone mounted on subjects while they performed several activities such as walking upstairs, standing and laying, with each being one of the 561 raw or processed quantities from the sensors on the phone. Ames refers to a housing dataset with the goal of predicting residential housing prices based on each features of the home. IEEE-CIS Fraud Detection refers to a dataset with the goal of identifying fraudulent transactions from numerous transaction and identity dependent features. The adversarial nature of the task, the nature of fraudsters adapting themselves and yielding different fraud patterns, cause the data to be highly non i.i.d., thus making feature selection important given that high capacity models can be prone to overfitting and poor generalization.

FIG. 6 depicts a table comparing accuracy for the sparse learnable masks system to other feature selection approaches over various datasets. The table illustrates selecting 50 features across a wide range of high dimensional datasets, most with >400 features. The table shows that the SLM consistently yields competitive performance, outperforming all other approaches in all cases except on Mice and Ames, for both of which the performance was saturated due to the small numbers of original features, making feature selection less relevant. Most other feature selection approaches are not consistent in their performance while SLM had consistently strong performance. SLM even improved upon a baseline of using all features, which can likely be attributed to superior generalization when the limited model capacity is focused on the most salient features.

FIG. 7 depicts a table comparing accuracy for the sparse learnable masks system to other feature selection approaches over various numbers of features to be selected. The table focuses on the Fraud dataset and reports performance as a different number of selected features. The table illustrates that SLM outperforms the other approaches, and its performance degradation is smaller with less features.

Further, SLM can also be used for interpretation of global feature importance during inference, yielding the importance ranking of selected features. This can be highly desired in high-stakes applications, such as healthcare or finance, where an importance score can be more useful than simply whether a feature is selected or not. With respect to MI, SLM does not need to sample from the joint or marginal distributions, a potentially computationally intensive process, and does not require a contrastive term in the estimation of MI, resulting in less computational cost. SLM accounts for feature inter-dependence by learning inter-dependent probabilities for the selected feature, where the inter-dependent probabilities jointly maximize the MI between features and labels. Furthermore, SLM learns feature selection and the task objective in an end-to-end manner, which alleviates the selection of repetitive features that may individually be predictive, but less predictive over an individually predictive but redundant feature. SLM can improve generalization, especially for high capacity models like deep neural networks, as they can easily overfit patterns from spurious features that do not hold across training and test data splits. For instance, the table in FIG. 6 shows that in some cases, especially with SLM, prediction on a subset of features can outperform that on all features.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” or “data processing system” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method for training a machine learning model with scalable feature selection, comprising:
receiving, by one or more processors, a plurality of features for training the machine learning model;
initializing, by the one or more processors, a learnable mask vector representing the plurality of features;
receiving, by the one or more processors, a number of features to be selected;
generating, by the one or more processors, a sparse mask vector from the learnable mask vector;
selecting, by the one or more processors, a selected set of features of the plurality of features based on the sparse mask vector and the number of features to be selected;
computing, by the one or more processors, a mutual information based error based on the selected set of features being input into the machine learning model; and
updating, by the one or more processors, the learnable mask vector based on the mutual information based error.

2. The method of claim 1, further comprising receiving, by the one or more processors, a total number of training steps.

3. The method of claim 2, wherein the receiving, generating, selecting, computing, and updating is iterative for the total number of training steps.

4. The method of claim 3, wherein the learnable mask vector updated after the total number of training steps comprises a final selected set of features to be utilized by the machine learning model.

5. The method of claim 1, wherein training the machine learning model further comprises gradient-descent based learning.

6. The method of claim 1, further comprising removing non-selected features of the plurality of features.

7. The method of claim 1, further comprising applying a sparsemax normalization to the learnable mask vector.

8. The method of claim 1, further comprising decreasing the number of features over a total number of training steps until reaching a target number of features to be selected.

9. The method of claim 8, wherein gradually decreasing the number of features to be selected is based on a discrete number of evenly spaced steps.

10. The method of claim 1, wherein selecting the selected set of features further comprises multiplying the sparse vector by a positive scalar based on a predetermined number of features.

11. The method of claim 1, wherein computing the mutual information based error is based on maximizing mutual information between a distribution of the selected set of features and a distribution of labels for the selected set of features.

12. The method of claim 1, wherein updating the learnable mask vector is based on minimizing the mutual information based error.

13. A system comprising:
one or more processors; and
one or more storage devices coupled to the one or more processors and storing instructions that, when executed by the one or more processors, cause the one or more processors to perform operations for training a machine learning model with scalable feature selection, the operations comprising:
receiving a plurality of features for training the machine learning model;
initializing a learnable mask vector representing the plurality of features;
receiving a number of features to be selected;
generating a sparse mask vector from the learnable mask vector;
selecting a selected set of features of the plurality of features based on the sparse mask vector and the number of features to be selected;
computing a mutual information based error based on the selected set of features being input into the machine learning model; and
updating the learnable mask vector based on the mutual information based error.

14. The system of claim 13, wherein:
the operations further comprise receiving a total number of training steps;
the receiving, generating, selecting, computing, and updating is iterative for the total number of training steps; and
the learnable mask vector updated after the total number of training steps comprises a final selected set of features to be utilized by the machine learning model.

15. The system of claim 13, wherein the operations further comprise removing non-selected features of the plurality of features.

16. The system of claim 13, wherein the operations further comprise applying a sparsemax normalization to the learnable mask vector.

17. The system of claim 13, wherein the operations further comprise gradually decreasing the number of features over a total number of training steps until reaching a target number of features to be selected.

18. The system of claim 13, wherein selecting the selected set of features further comprises multiplying the sparse vector by a positive scalar based on a predetermined number of features.

19. The system of claim 13, wherein computing the mutual information based error is based on maximizing mutual information between a distribution of the selected set of features and a distribution of labels for the selected set of features.

20. A non-transitory computer readable medium for storing instructions that, when executed by one or more processors, cause the one or more processors to perform operations for training a machine learning model with scalable feature selection, the operations comprising:
receiving a plurality of features for training the machine learning model;
initializing a learnable mask vector representing the plurality of features;
receiving a number of features to be selected;
generating a sparse mask vector from the learnable mask vector;
selecting a selected set of features of the plurality of features based on the sparse mask vector and the number of features to be selected;
computing a mutual information based error based on the selected set of features being input into the machine learning model; and
updating the learnable mask vector based on the mutual information based error.
